(19) United States
(12) Patent Application Publication
(10) Pub. No.: US 2016/0217143 A1
(43) Pub. Date: Jul. 28, 2016

(54) Method and device for displaying browser resources and computer readable storage medium

(71) Applicant: ZTE Corporation, Shenzhen, Guangdong (CN)

(72) Inventor: Gang CAO, Shenzhen (CN)

(21) Appl. No.: 14/915,009

(22) PCT Filed: Dec. 23, 2013
(86) PCT No.: PCT/CN2013/090261

§ 371 Date: Feb. 26, 2016

(30) Foreign Application Priority Data
Aug. 30, 2013 (CN) 201310389461.8

(51) Int. Cl. G06F 17/30; G06F 3/0482; H04L 29/08; G06F 3/0485

(52) U.S. Cl. CPC G06F 17/3089; G06F 3/04855; G06F 3/0482; H04L 67/10; H04L 67/02

(57) ABSTRACT

The present invention relates to a method and device for displaying browser resources and a computer readable storage medium. The method comprises: acquiring current location information about a scroll bar of a web page in a browser window and generating an area coverage of the web page covered by the window in accordance with the acquired location information; determining the resources to be displayed of the web page within the area coverage in accordance with layout information about each resource to be displayed of the web page in the web page; and downloading the determined resources to be displayed and correspondingly displaying the downloaded resources to be displayed within the area coverage.

### TECHNICAL FIELD

The disclosure relates to the technical field of browsers, and in particular to a browser resource display method and device and a computer-readable storage medium.

### BACKGROUND

Along with rapid development of a wireless communication technology and an Internet technology, more and more users surf the Internet by virtue of browsers on mobile terminals. Huger and huger data traffic generated by browsing simple mobile Wireless Application Protocol (WAP) sites and complex desktop World Wide Web (3W) sites through a browser of a mobile terminal, so that traffic control and saving of browsers is important for many users in a non-Wireless Fidelity (WIFI) network environment. In a current browser technology, there are mainly two manners for saving traffic of a browser; one is to compress web page data requested by a browser of a terminal through an intermediate server, thereby reducing traffic generated on the terminal, and such a manner has the advantage that the browser of the terminal is not required to perform any processing and the shortcoming that support of the intermediate server is required; and the other is implemented through a picture-free mode, that is, no pictures are loaded when a web page is browsed, and such a manner has the advantages that the intermediate server is not required and the way for reducing traffic is simple and effective and the shortcoming that a user may not browse any picture in the web page.

### SUMMARY

In order to solve the existing technical problems, the embodiments of the disclosure provide a browser resource display method and device and a computer-readable storage medium.

An embodiment of the disclosure discloses a browser resource display method, which may include that:

current position information of a scrollbar for a web page in a window of a browser is acquired, and an area range, covered by the window, of the web page is generated according to the acquired position information;

a resource to be displayed of the web page in the area range is determined according to layout information of each resource to be displayed of the web page in the web page; and

the determined resource to be displayed is downloaded, and the downloaded resource to be displayed is correspondingly displayed in the area range.

An embodiment of the disclosure further discloses a browser resource display device, which may include:

a generation module, configured to acquire current position information of a scrollbar for a web page in a window of a browser, and generate an area range, covered by the window, of the web page according to the acquired position information;

a determination module, configured to determine a resource to be displayed of the web page in the area range according to layout information of each resource to be displayed of the web page in the web page; and

a display module, configured to download the determined resource to be displayed, and correspondingly display the downloaded resource to be displayed in the area range.

An embodiment of the disclosure further discloses a computer-readable storage medium, which may include a set of instructions, the instructions being configured to implement the aforementioned browser resource display method.

According to the browser resource display method and device and computer-readable storage medium disclosed by the embodiment of the disclosure, a display range of the current window of the browser is acquired according to the position information of the scrollbar of the browser, and when the resource to be displayed is located in the display range of the current window of the browser, the resource to be displayed is downloaded, that is, when the scrollbar is dragged and the resource to be displayed enters the range of the window of the browser, the resource to be displayed is downloaded and displayed, and the other resources to be displayed which do not enter the range of the window of the browser are not required to be downloaded, so that traffic generated when a user uses the browser may be saved without an intermediate server.

### BRIEF DESCRIPTION OF THE DRAWINGS

FIG. 1 is a flowchart of a first embodiment of a browser resource display method according to the disclosure;

FIG. 2 is a specific flowchart of Step 20 in FIG. 1;

FIG. 3 is a flowchart of a second embodiment of a browser resource display method according to the disclosure;

FIG. 4 is a flowchart of a third embodiment of a browser resource display method according to the disclosure;

FIG. 5 is a structure diagram of a first embodiment of a browser resource display device according to the disclosure;

FIG. 6 is a structure diagram of a second embodiment of a browser resource display device according to the disclosure; and

FIG. 7 is a structure diagram of a third embodiment of a browser resource display device according to the disclosure.

### DETAILED DESCRIPTION

The technical solutions of the disclosure will be further described below with reference to the drawings and specific embodiments. It should be understood that the specific embodiments described here are only adopted to explain the disclosure and not intended to limit the disclosure.

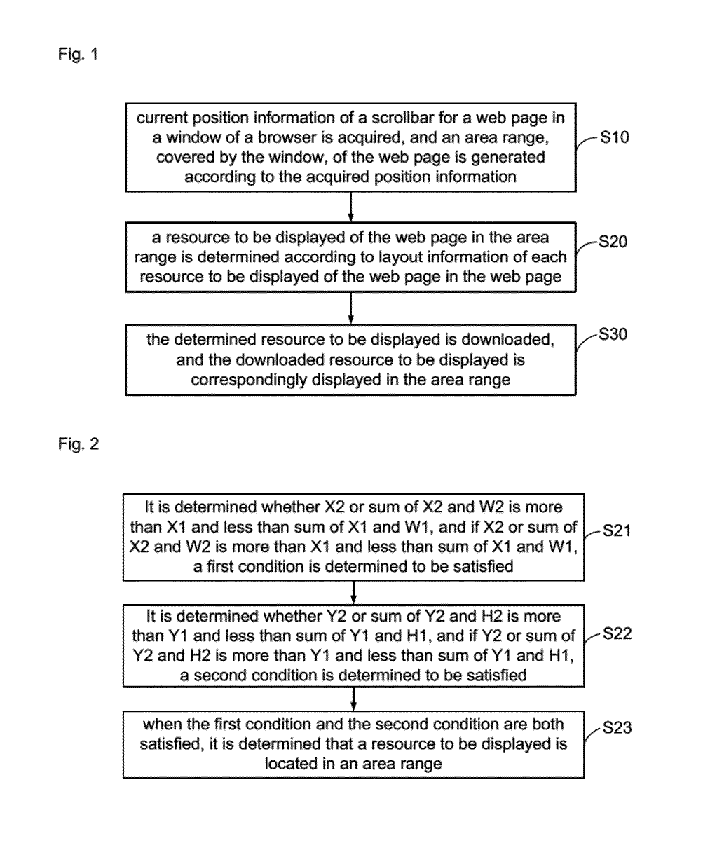

Referring to FIG. 1 and FIG. 2, FIG. 1 is a flowchart of a first embodiment of a browser resource display method according to the disclosure, and FIG. 2 is a specific flowchart of Step 20 in FIG. 1.

The embodiment discloses a browser resource display method, which includes:

Step 10: current position information of a scrollbar for a web page in a window of a browser is acquired, and an area range, covered by the window, of the web page is generated according to the acquired position information.

The current position information of the scrollbar includes a coordinate value X1 of a horizontal scrollbar of the window of the browser and a coordinate value Y1 of a vertical scrollbar, a coordinate base point in the embodiment may be the left upper corner of the web page, the position information of the scrollbar is (0,0) during initialization of the browser, that is, the coordinate values of the horizontal scrollbar and the vertical scrollbar are both 0, and when a user moves the scrollbar, the position information of the scrollbar is changed into (X1,Y1).

The area range, covered by the window, of the web page is determined by a current coordinate value X1 of the horizontal scrollbar in the range of the window, a current coordinate value Y1 of the vertical scrollbar, a height value W1 of the window and a width value H1 of the window, the area range is represented as (X1,Y1,W1,H1), values of W1 and H1 are determined according to a current state of the browser, whether the browser is in a full-screen display mode or not may be determined at first, and when the browser is in the full-screen display mode, W1 is a width of a screen of the terminal and H1 is a height of the screen of the terminal; when the browser is in a normal mode, if the browser displays with a normal size, W1 is the width of the screen of the terminal, H1 is a difference value between the height of the screen of the terminal and a width value of a toolbar of the browser, W1 and H1 in the full-screen display mode and the normal display mode may be preset, W1 and H1 are associated with the display mode of the browser for storage, and the area range (X1,Y1,W1,H1), covered by the window, of the web page is generated according to the current position information of the scrollbar and the display mode of the browser; and when the browser is in the normal display mode if the browser is scaled down to a certain ratio for display, current W1 and H1 are calculated according to W1 and H1 corresponding to the normal display mode and the display ratio to generate the corresponding area range (X1,Y1,W1,H1), covered by the window, of the web page.

Step 20, a resource to be displayed of the web page in the area range is determined according to layout information of each resource to be displayed of the web page in the web page.

When browser resources are received, the browser resources may be parsed into download addresses of multiple resources to be displayed, types of the resources to be displayed and a cascading style sheet of the resources to be displayed, the resources to be displayed include different types of resources such as pictures, videos and texts, the layout information of the resources to be displayed in a web page of the browser is generated according to styles and type-settings of the web page in the cascading style sheet and types and sizes of the resources to be displayed, and the layout information includes horizontal coordinate values X2 and vertical coordinate values Y2 of the resources to be displayed, height values H2 of the resources to be displayed and weight values W2 of the resources to be displayed. The resources to be displayed are preferably picture and video resources, all text information may be downloaded in display processes of the web page at first, and after the text information is downloaded, only the resources appearing in the area range, covered by the window, of the web page are downloaded. After the received browser resources are rparsed, ail the text information is downloaded at first, then the layout information of the resources to be displayed are associated with the download addresses of the other resources to be displayed for storage, and if the layout information of the resources to be displayed in the acquired resources to be displayed is in the area range, the resources to be displayed are downloaded according to the corresponding download addresses.

Referring to FIG. 2, Step 20 in the embodiment specifically includes the following steps;

Step 21, it is determined whether X2 or sum of X2 and W2 is more than X1 and less than sum of X1 and W1, and if X2 or sum of X2 and W2 is more than X1 and less than sum of X1 and W1, a first condition is determined to be satisfied;

Step 22, it is determined whether Y2 or sum of Y2 and H2 is more than Y1 and less than sum of Y1 and H1, and if Y2 or sum of Y2 and H2 is more than Y1 and less than sum of Y1 and H1, a second condition is determined to be satisfied; and

Step 23, when the first condition and the second condition are both satisfied, it is determined that the resource to be displayed is located in the area range.

A condition that the resources to be displayed of the web page are located in the area range is represented by a logic formula as follows: (X1<X2<X1+W1∥X1<X2+W2<X1+W1)&&(Y1<Y2<Y1+H1∥Y1<Y2+H2<Y1+H1).

When the user moves the scrollbar, the position information of the scrollbar is changed into (X1,Y1), the corresponding area range, covered by the window, of the web page are (X1,Y1,W1,H1), movement of the scrollbar is equivalent to movement of the window on the web page, and in the embodiment, the layout information of the resources to be displayed preferably takes the upper left corner of the web page of the browser as the base point, and the horizontal coordinate values X2 and vertical coordinate values Y2 of the resources to be displayed in the layout information (X2,Y2,W2,H2) of the resources to be displayed are preferably coordinates (X2,Y2) of the upper left corners of the resources to be displayed in the embodiment.

When the user moves the scrollbar, the area range (X1,Y1,W1,H1), covered by the current window, of the web page may be acquired at first, the layout information (X2,Y2,W2,H2) of the resource to be displayed is sequentially acquired, the acquired layout information (X2,Y2,W2,H2) is compared with the acquired area range (X1,Y1,W1,H1), it is indicated that a position of the left upper corner of a video resource to be displayed is located in the display range of the current window if X1<X2<X1+W1 and Y1<Y2<: Y1+H1, and for example, when the horizontal scrollbar is dragged rightwards and/or the vertical scrollbar is dragged downwards, the position of the left upper corner of the resource to be displayed may appear in the window, and then the resource to be displayed may be downloaded; if X1<X2+W2<X1+W1 and Y1<Y2+H2<Y1+H1, it is indicated the position of the left upper corner of the resource to be displayed is not within the display range of the current window, but part of the resource to be displayed is displayed in the area range, covered by the current window, of the web page; and for example, if the user drags the scrollbar greatly, or the user drags the horizontal scrollbar leftwards and/or drags the vertical scrollbar upwards, the position of the left upper corner of the resource to be displayed may appear in the display range of the window, but part of the resource to be displayed appears in the display area of the window, and then the resource to be displayed is downloaded and displayed for the user to watch to improve user experiences.

Step 30 the determined resource to be displayed is downloaded, and the downloaded resource to be displayed is correspondingly displayed in the area range,

Before the resources to be displayed are downloaded, whether the resources to be displayed have been downloaded or not may be determined. Since the user may repeatedly browse a certain part of the web page, some resources to be displayed may have been downloaded. Then, it is unnecessary to re-download the resources to be displayed, and the downloaded resources to be displayed are only required to be called from a storage device, so that resource waste caused by repeated download is avoided,

In the embodiment, when the browser resources are received, the browser resources are parsed into the download addresses of the multiple resources to be displayed, each resource to be displayed corresponds to a download address, and if the resources to be displayed are determined to enter the area range, covered by the current window, of the web page, the resources to be displayed are downloaded according to the parsed download addresses, and the download addresses are preferably web page addresses.

According to the browser resource downloading method disclosed by the embodiment, the display range of the current window of the browser is acquired according to the position information of the scrollbar of the browser, and when the resource to be displayed is located in the display range of the current window of the browser, the resource to be displayed is downloaded, that is, when the scrollbar is dragged and the resource to be displayed enters the range of the window of the browser, the resource to be displayed is downloaded and displayed, and the other resources to be displayed which do not enter the range of the window of the browser are not required to be downloaded, so that traffic generated when a user uses the browser may be saved without an intermediate server,

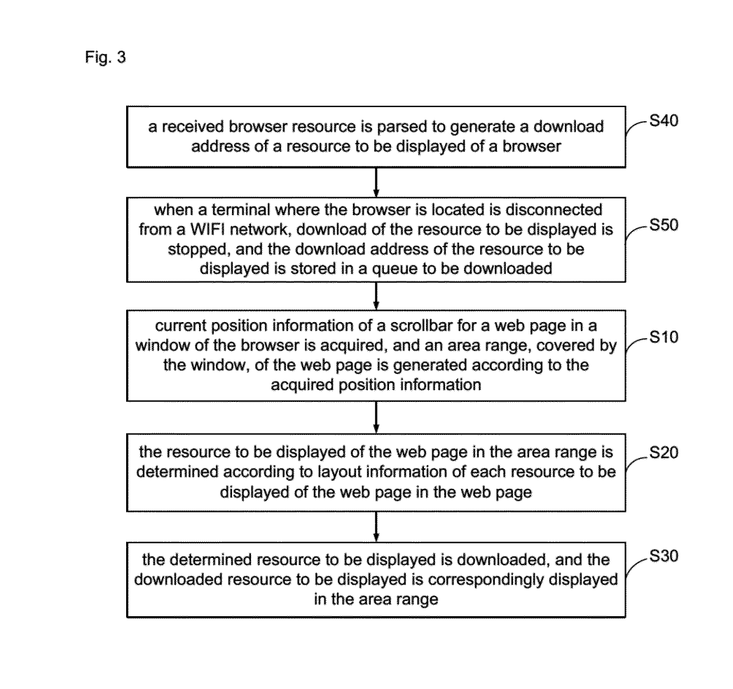

Referring to FIG. 3, FIG. 3 is a flowchart of a second embodiment of a browser resource display method according to the disclosure.

A second embodiment of a browser resource display method of the disclosure is disclosed on the basis of the first embodiment, and in the embodiment, before Step 10, the method further includes:

Step 40: the received browser resource is parsed to generate the download address of the resource to be displayed of the browser; and

Step 50: when a terminal where the browser is located is disconnected from a WIFI network, download of the resource to be displayed is stopped, and the download address of the resource to be displayed is stored in a queue to be downloaded.

When the user starts the browser or the user opens the web page, the browser resource sent by a server may be received, and the browser resource is parsed to acquire the download address of each resource to be displayed (such as a text, a picture and a video). Since a mobile terminal such as a mobile phone may be connected to a WIFI network, and may also be connected with another mobile 2-Generation/3-Generation (2G/3G) network and the 2G/3G network and the like are higher in cost, all the resources to be displayed may be downloaded in a WIFI network environment, and under a connection with another network such as the 2G/3G network, resources to be displayed, such as texts and tables, with lower traffic may be downloaded at first according to the types of the resources to be displayed, download addresses of resources to be displayed, such as pictures and videos, with higher traffic are stored in the queue to be downloaded, and when the resources to be displayed, such as the pictures and the videos, with higher traffic enter the area ranges, covered by the window, of the web pages, the resources to be displayed, such as the pictures and videos, with higher traffic in the queue to be downloaded are downloaded; or under the connection with the other network such as the 2G/3G network, download of all the resources to be displayed is stopped, and when the resources to be displayed enter the area ranges, covered by the window, of the web pages, the resources to be displayed entering the area ranges, covered by the window, of the web pages are downloaded.

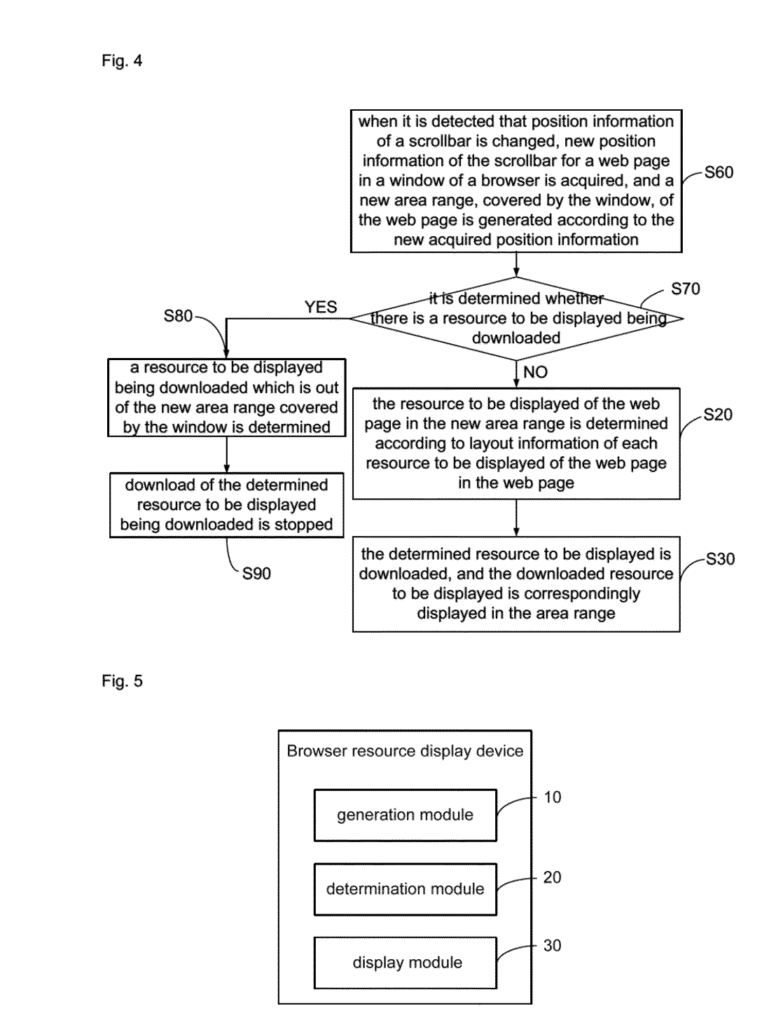

Referring to FIG. 4, FIG. 4 is a flowchart of a third embodiment of a browser resource display method according to the disclosure.

A third embodiment of a browser resource display method of the disclosure is disclosed on the basis of the first embodiment, and in the embodiment, the method further includes:

Step 60: when it is detected that the position information of the scrollbar is changed, new position information of the scrollbar for the web page in the window of the browser is acquired, and a new area range, covered by the window, of the web page is generated according to the acquired new position information;

Step 70: it is determined whether there is a resource to be displayed being downloaded;

Step 80: if there is a resource to be displayed being downloaded, a resource to be displayed being downloaded which is out of the new area range covered by the window is determined; and

Step 90: download of the determined resource to be displayed being downloaded is stopped.

If there is no resource to be displayed being downloaded, Step 20 is executed, and the resource to be displayed of the web page in the area range is determined according to the layout information of each resource to be displayed of the web page in the web page.

Since the user may continuously drag the scrollbar to a certain position, when the position information of the scrollbar is detected to be continuously changed, the resource to be displayed continuously appearing in the range of the window is not downloaded until information indicating that the position information of the scrollbar stops changing is received, display range information of the current window is acquired, layout information of picture and video resources to be displayed is traversed, and the resource to be displayed in the area range of the window is downloaded.

When the information of the scrollbar is changed by frequently dragging the scrollbar by the user, the resource to be displayed being downloaded has not been within the area range of the window, then download of the resource to be displayed not within the display range of the window may be stopped and download of the other resources to be displayed within the display range of the window may be started, so that traffic generated by the terminal where the browser is located is saved.

Referring to FIG. 5, FIG. 5 is a structure diagram of a first embodiment of a browser resource display device according to the disclosure.

The embodiment discloses a browser resource display device, which includes:

a generation module 10, configured to acquire current position information of a scrollbar for a web page in a window of a browser, and generate an area range, covered by the window, of the web page according to the acquired position information.

The current position information of the scrollbar includes a coordinate value X1 of a horizontal scrollbar of the window of the browser and a coordinate value Y1 of a vertical scrollbar, a coordinate base point in the embodiment may be the left upper corner of the web page, the position information of the scrollbar is (0,0) during initialization of the browser, that is, the coordinate values of the horizontal scrollbar and the vertical scrollbar are both 0, and when a user moves the scrollbar, the position information of the scrollbar is changed into (X1,Y1).

The area range, covered by the window, of the web page is determined by a current coordinate value X1 of the horizontal scrollbar in the range of the window, a current coordinate value Y1 of the vertical scrollbar, a height value W1 of the window and a width value H1 of the window, the area range is represented as (X1,Y1,W1,H1), values of W1 and H1 are determined according to a current state of the browser, whether the browser is in a full-screen display mode or not may be determined at first, and when the browser is in the full-screen display mode, W1 is a width of a screen of the terminal and H1 is a height of the screen of the terminal; when the browser is in a normal mode, if the browser displays with a normal size, W1 is the width of the screen of the terminal, H1 is a difference value between the height of the screen of the terminal and a width value of a toolbar of the browser, W1 and H1 in the full-screen display mode and the normal display mode may be preset, W1 and H1 are associated with the display mode of the browser for storage, and the area range (X1,Y1,W1,H1), covered by the window, of the web page is generated according to the current position information of the scrollbar and the display mode of the browser; and when the browser is in the normal display mode if the browser is scaled down to a certain ratio for display, current W1 and H1 are calculated according to W1 and H1 corresponding to the normal display mode and the display ratio to generate the corresponding area range (X1,Y1,W1,H1), covered by the window, of the web page.

a determination module 20, configured to determine a resource to be displayed of the web page in the area range according to layout information of each resource to be displayed of the web page in the web page.

When browser resources are received, the browser resources may be parsed into download addresses of multiple resources to be displayed, types of the resources to be displayed and a cascading style sheet of the resources to be displayed, the resources to be displayed include different types of resources such as pictures, videos and texts, the layout information of the resources to be displayed in web pages of the browser is generated according to styles and type-settings of the web pages in the cascading style sheet and types and sizes of the resources to be displayed, and the layout information includes horizontal coordinate values X2 and vertical coordinate values Y2 of the resources to be displayed, height values H2 of the resources to be displayed and weight values W2 of the resources to be displayed. The resources to be displayed are preferably picture and video resources, all text information may be downloaded in display processes of the web pages at first, and after the text information is downloaded, only the resources appearing in the area range, covered by the window, of the web pages are downloaded. After the received browser resources are parsed, all the text information is downloaded at first, then the layout information of the resources to be displayed are associated with the download addresses of the other resources to be displayed for storage, and if the layout information of the resources to be displayed in the acquired resources to be displayed is in the area range, the resources to be displayed are downloaded according to the corresponding download addresses.

The operation that the determination module 20 determines the resource to be displayed of the web page in the area range is specifically implemented by the following process of: determining whether X2 or sum of X2 and W2 is more than X1 and less than sum of X1 and W1 or not, and if X2 or sum of X2 and W2 is more than X1 and less than sum of X1 and W1, determining that a first condition is satisfied; determining whether Y2 or sum of Y2 and H2 is more than Y1 and less than sum of Y1 and H1 or not, and if Y2 or sum of Y2 and H2 is more than Y1 and less than sum of Y1 and H1 determining that a second condition is satisfied; and when the first condition and the second condition are both satisfied, determining that the resources to be displayed are located in the area range.

A condition that the resources to be displayed of the web page are located in the area range is represented by a logic formula as follows: (X1<X2<X1+W1∥X1<X2+W2<X1+W1)&&(Y1<Y2<Y1+H1∥Y1<Y2+H2<Y1+H1).

When the user moves the scrollbar, the position information of the scrollbar is changed into (X1,Y1), the corresponding area ranges, covered by the window, of the web page are (X1,Y1,W1,H1), movement of the scrollbar is equivalent to movement of the window on the web page, and in the embodiment, the layout information of the resources to be displayed preferably takes the upper left corner of the web page of the browser as the base point, and the horizontal coordinate values X2 and vertical coordinate values Y2 of the resources to be displayed in the layout information (X2,Y2,W2,H2) of the resources to be displayed are preferably coordinates (X2,Y2) of the upper left corners of the resources to be displayed in the embodiment,

When the user moves the scrollbar, the area range (X1,V1,W1,H1), covered by the current window, of the web page may be acquired at first, the layout information (X2,Y2,W2,H2) of the resource to be displayed is sequentially acquired, the acquired layout information (X2,Y2,W2,H2) is compared with the acquired area range (X1,Y1,W1,H1), it is indicated that a position of the left upper corner of a video resource to be displayed is located in the display range of the current window if X1<X2<X1+W1 and Y1<Y2<V1+H1, and for example, when the horizontal scrollbar is dragged rightwards and/or the vertical scrollbar is dragged downwards, the position of the left upper corner of the resource to be displayed may appear in the window, and then the resource to be displayed may be downloaded; if X1<X2+W2<X1+W1 and Y1<Y2+H2<Y1+H1, it is indicated the position of the left upper corner of the resource to be displayed is not within the display range of the current window, but part of the resource to be displayed is displayed in the area range, covered by the current window, of the web page; and for example, if the user drags the scrollbar greatly, or the user drags the horizontal scrollbar leftwards and/or drags the vertical scrollbar upwards, the position of the left upper corner of the resource to be displayed may appear in the display range of the window, but part of the resource to be displayed appears in the display area of the window, and then the resource to be displayed is downloaded and displayed for the user to watch to improve user experiences.

a display module 30, configured to download the determined resource to be displayed, and correspondingly display the downloaded resource to be displayed in the area range.

Before the resources to be displayed are downloaded, whether the resources to be displayed have been downloaded or not may be determined. Since the user may repeatedly browse a certain part of the web page, some resources to be displayed may have been downloaded. Then, it is unnecessary to re-download the resources to be displayed, and the downloaded resources to be displayed are only required to be called from a storage device, so that resource waste caused by repeated download is avoided.

In the embodiment, when the browser resources are received, the browser resources are parsed into the download addresses of the multiple resources to be displayed, each resource to be displayed corresponds to a download address, and if the resources to be displayed are determined to enter the area range, covered by the current window, of the web page, the resources to be displayed are downloaded according to the parsed download addresses, and the download addresses are preferably web page addresses.

According to the browser resource download device disclosed by the embodiment, the display range of the current window of the browser is acquired according to the position information of the scrollbar of the browser, and when the resource to be displayed is located in the display range of the current window of the browser, the resource to be displayed is downloaded, that is, when the scrollbar is dragged and the resource to be displayed enters the range of the window of the browser, the resource to be displayed is downloaded and displayed, and the other resources to be displayed which do not enter the range of the window of the browser are not required to be downloaded, so that traffic generated when a user uses the browser may be saved without an intermediate server.

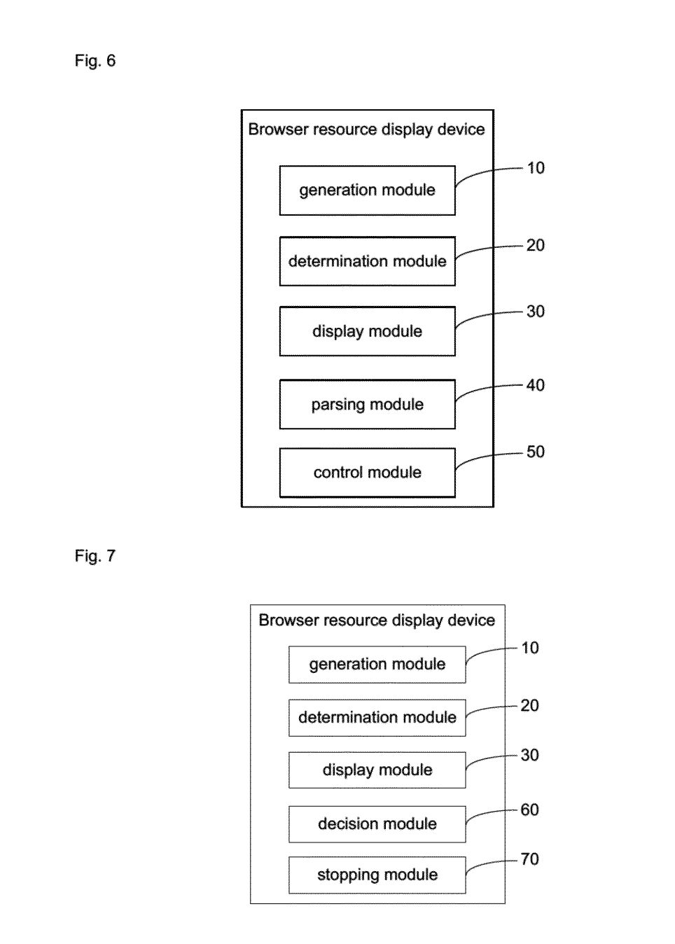

Referring to FIG. 6, FIG. 6 is a flowchart of a second embodiment of a browser resource display device according to the disclosure.

A second embodiment of a browser resource display device of the disclosure is disclosed on the basis of the first embodiment, and in the embodiment, the device further includes:

a parsing module 40, configured to parse the received browser resource to generate the download address of the resource to be displayed of the browser; and

a control module 50, configured to, when a terminal where the browser is located is disconnected from a WIFI network, stop download of the resource to be displayed, and store the download address of the resource to be displayed in a queue to be downloaded.

When the user starts the browser or the user opens the web page, the browser resource sent by a server may be received, and the browser resource is parsed to acquire the download address of each resource to be displayed (such as a text, a picture and a video). Since a mobile terminal such as a mobile phone may be connected to a WIFI network, and may also be connected with another mobile 2-Generation/3-Generation (2G/3G) network and the 2G/3G network and the like are higher in cost, all the resources to be displayed may be downloaded in a WIFI network environment, and under a connection with another network such as the 2G/3G network, resources to be displayed, such as texts and tables, with lower traffic may be downloaded at first according to the types of the resources to be displayed, download addresses of resources to be displayed, such as pictures and videos, with higher traffic are stored in the queue to be downloaded, and when the resources to be displayed, such as the pictures and the videos, with higher traffic enter the area ranges, covered by the window, of the web pages, the resources to be displayed, such as the pictures and videos, with higher traffic in the queue to be downloaded are downloaded; or under the connection with the other network such as the 2G/3G network, download of all the resources to be displayed is stopped, and when the resources to be displayed enter the area ranges, covered by the window, of the web pages, the resources to be displayed entering the area ranges, covered by the window, of the web pages are downloaded.

Referring to FIG. 7, FIG. 7 is a flowchart of a third embodiment of a browser resource display device according to the disclosure.

In the first embodiment and second embodiment of the browser resource download device of the disclosure,

the generation module 10 is further configured to, when it is detected that the position information of the scrollbar is changed, acquire new position information of the scrollbar for the web page in the window of the browser, and generate a new area range, covered by the window, of the web page according to the acquired new position information; the device further includes a decision module 60, configured to determine whether there is a resource to be displayed being downloaded or not; the determination module 20 is further configured to, if there is a resource to be displayed being downloaded, determine a resource to be displayed being downloaded which is out of the new area range covered by the window; the device further includes a stopping module 70, configured to stop download of the determined resource to be displayed being downloaded; and the determination module 20 is further configured to, if there is no resource to be displayed being downloaded, determine a resource to be displayed of the web page in the new area range according to the layout information of each resource to be displayed of the web page in the web page.

Since the user may continuously drag the scrollbar to a certain position, when the position information of the scrollbar is detected to be continuously changed, the resource to be displayed continuously appearing in the range of the window is not downloaded until information indicating that the position information of the scrollbar stops changing is received, display range information of the current window is acquired, layout information of picture and video resources to be displayed is traversed, and the resource to be displayed in the area range of the window is downloaded.

When the information of the scrollbar is changed by frequently dragging of the scrollbar by the user, the resource to be displayed being downloaded has not been within the area range of the window, then download of the resource to be displayed not within the display range of the window may be stopped and download of the other resources to be displayed within the display range of the window may be started, so that traffic generated by the terminal where the browser is located is saved

The browser resource display device provided by the embodiment of the disclosure may be applied to a terminal. In addition, the generation module 10, the determination module 20, the display module 30, the parsing module 40, the control module 50, the decision module 60 and the stopping module 70 may be implemented by a Central Processing Unit (CPU), Micro Processing Unit (MPU), Digital Signal Processor (DSP) or Field-Programmable Gate Array (FPGA) in the browser resource display device.

Those skilled the art should know that the embodiment of the disclosure may be provided as a method, a system or a computer program product. Therefore, the disclosure may adopt a form of pure hardware embodiment, pure software embodiment and combined software and hardware embodiment. Moreover, the disclosure may adopt a form of computer program product implemented on one or more computer-available storage media (including, but not limited to, a disk memory, a Compact Disc Read-Only Memory (CD-ROM) and an optical memory) including computer-available program codes.

The disclosure is described with reference to flowcharts and/or block diagrams of the method, equipment (system) and computer program product according to the embodiment of the disclosure. It should be understood that each flow and/or block in the flowcharts and/or the block diagrams and combinations of the flows and/or blocks in the flowcharts and/or the block diagrams may be implemented by computer program instructions. These computer program instructions may be provided for a universal computer, a dedicated computer, an embedded processor or a processor of other programmable data processing equipment to generate a machine, so that a device for realizing a function specified in one flow or more flows in the flowcharts and/or one block or more blocks in the block diagrams is generated by the instructions executed through the computer or the processor of the other programmable data processing equipment.

These computer program instructions may also be stored in a computer-readable memory capable of guiding the computer or the other programmable data processing equipment to work in a specific manner, so that a product including an instruction device may be generated by the instructions stored in the computer-readable memory, the instruction device realizing the function specified in one flow or many flows in the flowcharts and/or one block or many blocks in the block diagrams.

These computer program instructions may further be loaded onto the computer or the other programmable data processing equipment, so that a series of operating steps are executed on the computer or the other programmable data processing equipment to generate processing implemented by the computer, and steps for realizing the function specified in one flow or many flows in the flowcharts and/or one block or many blocks in the block diagrams are provided by the instructions executed on the computer or the other programmable data processing equipment.

The embodiment of the disclosure further discloses a computer-readable storage medium, which includes a set of instructions, the instructions being configured to execute the browser resource display method.

The above is only the preferred embodiment of the disclosure and not intended to limit the scope of patent of the disclosure, and all equivalent structural transformations made by virtue of contents of the specification and drawings of the disclosure or direct or indirection application of the contents to other related arts shall similarly fall within the scope of protection of the disclosure.

What is claimed is:

1. A browser resource display method, comprising:
acquiring current position information of a scrollbar for a web page in a window of a browser, and generating an area range, covered by the window, of the web page according to the acquired position information;
determining a resource to be displayed of the web page in the area range according to layout information of each resource to be displayed of the web page in the web page; and
downloading the determined resource to be displayed, and
correspondingly displaying the downloaded resource to be displayed in the area range.

2. The method according to claim 1, wherein the area range is determined by a current coordinate value X1 of a horizontal scrollbar for the web page, a current coordinate value Y1 of a vertical scrollbar, a height value H1 of the window and a width value W1 of the window; and the layout information is determined by a horizontal coordinate value X2 and vertical coordinate value Y2 of the or each resource to be displayed, a height value H2 of the resource to be displayed and a width value W2 of the or each resource to be displayed.

3. The method according to claim 2, wherein the step of determining the resource to be displayed of the web page in the area range comprises:
if X2 or sum of X2 and W2 is more than X1 and less than sum of X1 and W1, determining that a first condition is satisfied;
if Y2 or sum of Y2 and H2 is more than Y1 and less than sum of Y1 and H1, determining that a second condition is satisfied; and
when the first condition and the second condition are both satisfied, determining that the resource to be displayed is located in the area range.

4. The method according to claim 1, further comprising: before the step of acquiring the current position information of the scrollbar for the web page in the window of the browser,
parsing a received browser resource to generate a download address of a resource to be displayed of the browser; and
when a terminal where the browser is located is disconnected from a Wireless Fidelity (WIFI) network, stopping download of the resource to be displayed, and storing the download address of the resource to be displayed into a queue to be downloaded.

5. The method according to claim 1, further comprising:
when it is detected that position information of the scrollbar for the web page is changed, acquiring new position information of the scrollbar for the web page in the window of the browser, and generating a new area range, covered by the window, of the web page according to the acquired new position information; and
determining whether there is a resource to be displayed being downloaded.

6. The method according to claim 5, further comprising:
if there is a resource to be displayed being downloaded, determining a resource to be displayed being downloaded which is out of the new area range covered by the window, and stopping download of the determined resource to be displayed being downloaded.

7. The method according to claim 5, further comprising:
if there is no resource to be displayed being downloaded, determining a resource to be displayed of the web page in the new area range according to the layout information of each resource to be displayed of the web page in the web page.

8. A browser resource display device, comprising:
a generation module, configured to acquire current position information of a scrollbar for a web page in a window of a browser, and generate an area range, covered by the window, of the web page according to the acquired position information;
a determination module, configured to determine a resource to be displayed of the web page in the area range according to layout information of each resource to be displayed of the web page in the web page; and
a display module, configured to download the determined resource to be displayed, and correspondingly display the downloaded resource to be displayed in the area range.

9. The device according to claim 8, wherein the area range is determined by a current coordinate value X1 of a horizontal scrollbar for the web page, a current coordinate value Y1 of a vertical scrollbar, a height value H1 of the window and a width value W1 of the window; and the layout information is determined by a horizontal coordinate value X2 and vertical coordinate value Y2 of the or each resource to be displayed, a height value H2 of the resource to be displayed and a width value W2 of the or each resource to be displayed.

10. The device according to claim 9, wherein the determination module is specifically configured to determine whether X2 or sum of X2 and W2 is more than X1 and less than sum of X1 and W1 or not, and if X2 or sum of X2 and W2 is more than X1 and less than sum of X1 and W1, determine that a first condition is satisfied; determine whether Y2 or sum of Y2 and H2 is more than Y1 and less than sum of Y1 and H1 or not, and if Y2 or sum of Y2 and H2 is more than Y1 and less than sum of Y1 and H1, determine that a second condition is satisfied; and when the first condition and the second condition are both satisfied, determine that the resource to be displayed is located in the area range.

11. The device according to claim 8, further comprising:
a parsing module, configured to parse a received browser resource to generate a download address of a resource to be displayed of the browser; and
a control module, configured to, when a terminal where the browser is located is disconnected from a Wireless Fidelity (WIFI) network, stop download of the resource to be displayed, and store the download address of the resource to be displayed into a queue to be downloaded.

12. The device according to claim 8, wherein the generation module is further configured to, when detecting that position information of the scrollbar is changed, acquire new position information of the scrollbar for the web page in the window of the browser, and generate a new area range, covered by the window, of the web page according to the acquired new position information; and
the device further comprises a decision module, configured to determine whether there is a resource to be displayed being downloaded.

13. The device according to claim 12, wherein
the determination module is further configured to, if there is a resource to be displayed being downloaded, determine a resource to be displayed being downloaded which is out of the new area range covered by the window; and
the device further includes a stopping module, configured to stop download of the determined resource to be displayed being downloaded.

14. The device according to claim 12, wherein
the determination module is further configured to, if there is no resource to be displayed being downloaded, determine a resource to be displayed of the web page in the new area range according to the layout information of each resource to be displayed of the web page in the web page.

15. A computer-readable storage medium,
comprising a set of instructions, the instructions being configured to implement steps of:
acquiring current position information of a scrollbar for a web page in a window of a browser, and generating an area range, covered by the window, of the web page according to the acquired position information;
determining a resource to be displayed of the web page in the area range according to layout information of each resource to be displayed of the web page in the web page; and
downloading the determined resource to be displayed, and correspondingly displaying the downloaded resource to be displayed in the area range.
